(19) United States
(12) Patent Application Publication
(10) Pub. No.: US 2008/0209611 A1
(43) Pub. Date: Sep. 4, 2008

(54) GARMENT AND LINER SYSTEM

(75) Inventor: Stephen Tyrrell, Norwich (GB)

Correspondence Address: THOMPSON HINE L.L.P.;Intellectual Property Group, P.O. BOX 8801, DAYTON, OH, 45401-8801, US

(73) Assignee: LION APPAREL, INC., Dayton, OH (US)

(21) Appl. No.: 11/859,214

(22) Filed: Sep. 21, 2007

(30) Foreign Application Priority Data
Sep. 22, 2006 (GB) 0618617.5

(51) Int. Cl. A41D 1/06; A62B 17/00; A41D 3/02; A41D 27/02

(52) U.S. Cl. 2/79; 2/81; 2/97; 2/227; 2/272; 2/93

(57) ABSTRACT

A garment outer shell and liner system including a garment outer shell and a first liner having first protective properties and having a protruding portion. The system further includes a second liner having second protective properties differing from the first protective properties and having a protruding portion. Each liner is adapted to fit within, and is removably securable to, the outer shell. Each protruding portion is arranged to protrude from the outer shell when the respective liner is secured within the outer shell. At least a portion of the protruding portion of the first liner is a first color so as to indicate the first protective properties, and at least a portion of the protruding portion of the second liner is a second color so as to indicate the second protective properties.

This application claims priority to GB Application No. 0618617.5, filed on Sep. 22, 2006, the entire contents of which are hereby incorporated by reference.

The present invention relates to a protective garment, and more particularly, to a protective garment having a liner.

### BACKGROUND

Fire service personnel are required to perform a range of duties which require various clothing requirements which may be e set out in official standards. For example, National Fire Protection Association (“N.F.P.A.”) 1971 sets forth standards for protective firefighting garments (“Protective Clothing for Structural Firefighting”), and may focus upon standards relating to flammability, moisture resistance, thermal protection, etc. National Fire Protection Association (“N.F.P.A.”) 1951 sets forth standards for technical rescue garments (“Protective Ensembles for Technical Rescue Garments”) and may focus upon standards relating to protection from chemical, biological, and/or radioactive dangers.

### SUMMARY

In one embodiment the present invention is a garment outer shell and liner system which can meet various standards requirements. More particularly, in one embodiment the invention is a garment outer shell and liner system including a garment outer shell and a first liner having first protective properties and having a protruding portion. The system further includes a second liner having second protective properties differing from the first protective properties and having a protruding portion. Each liner is adapted to fit within, and is removably securable to, the outer shell. Each protruding portion is arranged to protrude from the outer shell when the respective liner is secured within the outer shell. At least a portion of the protruding portion of the first liner is a first color so as to indicate the first protective properties, and at least a portion of the protruding portion of the second liner is a second color so as to indicate the second protective properties.

### BRIEF DESCRIPTION OF THE DRAWINGS

FIG. 1 is a front view of a jacket outer shell;

FIG. 2 is a front view of a jacket liner for use with the jacket outer shell of FIG. 1;

FIG. 3 is a front view of a trousers outer shell;

FIG. 4 is a rear view of the trousers outer shell of FIG. 3; and

FIG. 5 is a front view of a trousers liner for use with the trousers outer shell of FIGS. 3 and 4.

### DETAILED DESCRIPTION

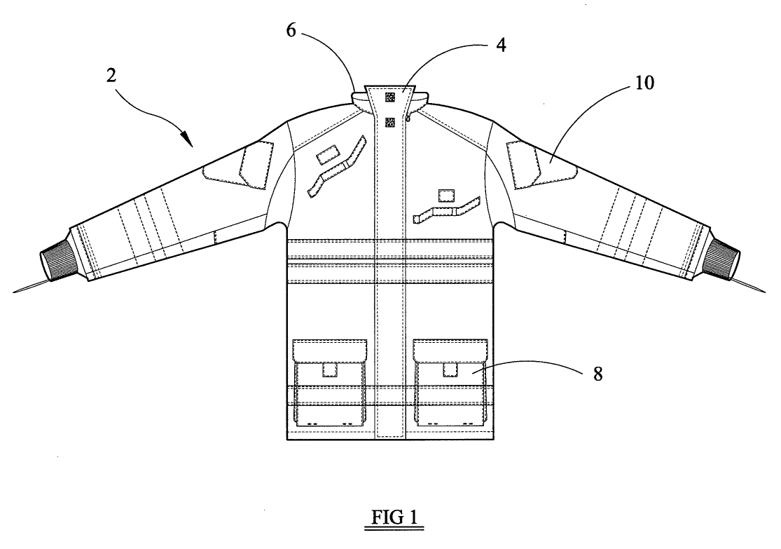

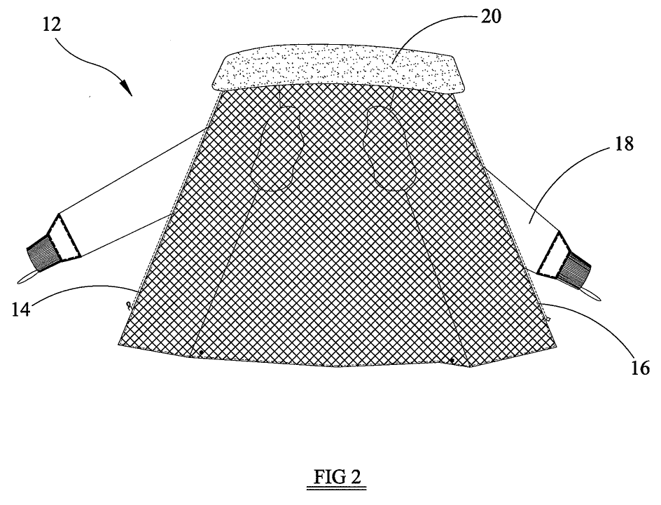

FIG. 1 shows a jacket outer shell 2 which includes a storm flap 4 which covers a fastener (not shown) for closing the outer shell 2, and which covers the front of a collar 6. Two bellowed pockets 8 and an angled sleeve pocket 10 are provided on the outer shell 2. The jacket outer shell 2 may be sold, packaged, or provided with two or more jacket liners 12, one of which is shown in FIG. 2. For simplicity, only one jacket liner 12 is shown in FIG. 2, but both jacket liners 12 may have substantially the same size, shape and appearance (except for color or other indicia, as will be described in greater detail below), but the liners 12 may differ in performance/materials characteristics. Each jacket liner 12 may be provided with a closure in the form of cooperating zip portions 14 and 16 or the like, and may also include two sleeve portions 18 and a protruding portion/collar 20.

Each jacket liner 12 may have a different color or other visible indicia relative to the other, particularly on the protruding portion/collar 20. The collar 20 of each jacket liner 12 is designed to protrude above/beyond the collar 6 of the jacket outer shell 2 when the jacket liner 12 is properly positioned inside, and coupled to, the outer shell 2 such that the collar 20 is visible to a viewer (i.e. a non-wearer) of the jacket. In other words, the collar 20 of each jacket liner 12 may have a greater height than the collar 6 of the jacket outer shell 2. Each liner 12 may have differing protective qualities, and the color or other indicia on the collar 20 may be indicative of the particular protective qualities of that liner 12.

For example, in one embodiment a first one of the jacket liners 12 (or part thereof) is colored red and complies with National Fire Protection Association (“N.F.P.A.”) 1971 standards for protective firefighting garments, and/or European Norm standards EN469:1995 Level 2 or EN469:2005 Level 2. In this case the red liner is suitable for use with firefighter garments or dealing with firefighting structural hazards. In this embodiment the second or other jacket liner 12 (or part thereof) may be colored green and complies with N.F.P.A. 1951 standards for technical rescue, and/or standard EN469:2005 Level 1. In this case the green liner is suitable for technical rescue garments or dealing with non-structural hazards. The contents of these N.F.P.A. and EN standards/regulations are entirely incorporated by reference herein. It should be noted that when the shell 2 receives a liner 12 such that the garment that complies with one N.F.P.A/EN standard, the shell 2/liner 12 may not necessarily comply with another N.F.P.A./EN standard.

Because the collar 20 of each liner 12 may be brightly colored (i.e. red or green), the collar 20 provides a visual indication of which liner 12 is being worn inside the jacket outer shell 2. The colored collars 20 therefore provide an important safety advantage, and reduce the risk of a user inadvertently wearing the wrong liner 12 for the particular hazard to be dealt with. For example, a user grabbing a jacket shell 2 can instantaneously determine the nature of the liner 12 therein by recognizing the color or other indicia on the liner 12. In addition, other individuals working with and around the wearer can identify the nature of the liner 12 in the shell 2, and inform the wearer if an inappropriate liner 12 is being worn.

In one embodiment substantially the whole of each jacket liner 12 is of the same color (i.e. red or green) and/or carries the indicia. However, other embodiments are possible in which, for example, only the collar 20 (or part of the collar 20) is colored and/or carries the indicia. It will also be appreciated that various other colors besides red and green may be used to distinguish between the two liners 12. Moreover, besides color, the collars 20 or other portions of the jacket liners 12 can differ by other visual indicia or optical properties, such as patterns, textures, symbols (i.e. a flame, a symbol for radiation, etc.), shading, text, (i.e. the text “1971” or “firefighting”; or “1951” or “technical rescue”, etc.), the use of reflective or fluorescent material, etc. or combinations of these features.

Moreover, the liners 12 need not necessarily differ by their regulations/classification and can differ by any of a variety of protective qualities, such as thermal protection, moisture protection, flame resistance, abrasion resistance, chemical resistance, radiation or biological resistance, etc. For example, a lightweight liner, which is less thermally protective may have a first indicia on its collar 20 (i.e. the text “lightweight”), and a heavier liner that is more thermally protective may have a different, second indicia on its collar 20 (i.e. the text “heavy duty”). Moreover, although in the illustrated embodiment the protruding portion 20 takes the form of the collar, the protruding portion 20 may also or instead protrude at various other locations of the outer shell 2, such as at the bottom of the shell 2 or the ends of the sleeves. However, forming the protruding portion on/as the collar 20 may be advantageous in that the collar 20 provides a relatively high vantage point which that can be easily seen by a wearer (i.e. by looking in a mirror at the height of the user's head, which is a common mounting position for mirrors), can be easily seen by others (since it is as a relatively high position), and is not easily obscured (unlike other positions on the jacket which can be obscured by equipment that is being carried, by intervening objects (i.e. vehicles, equipment, etc.))

Each jacket liner 2 may be attached to the jacket outer shell 2 by attaching the zip portions 14 and 16 of the jacket liner 12 to concealed zips (not shown) within the jacket outer shell 2. Each jacket liner 12 can thereby be zipped into the jacket outer shell 2 to make one complete and integrated garment. However, besides zips, any of a wide variety of fastening devices can be used to couple each liner 12 to the outer shell 2, such as hooks, clasps, snaps, hook-and-loop fastening material (such as VELCRO® hook and loop fastening material) or the like. In one embodiment, the jacket outer shell 2 and jacket liners 12 only comply to the relevant N.F.P.A or EN standard when they are worn as one complete garment. In addition, any of a number of differing liners, which differing protective properties, may be utilized.

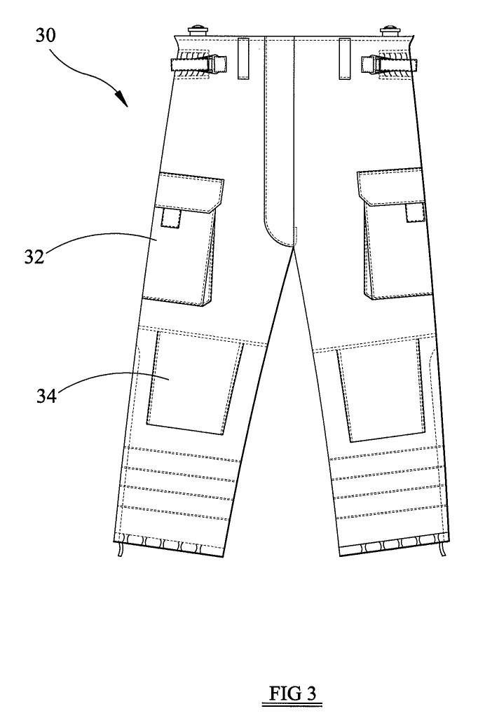

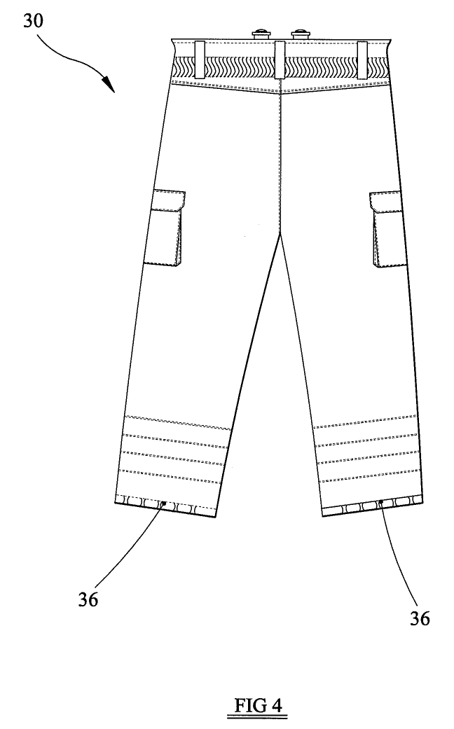

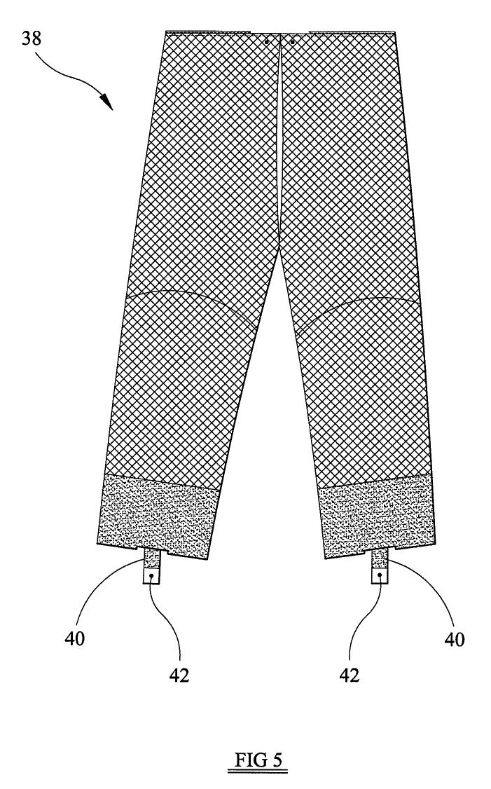

FIG. 3 shows a front view of a trousers outer shell 30. The trousers outer shell 30 is provided with two bellowed pockets 32 and two knee pads 34. FIG. 4 shows the rear of the trousers outer shell 30. The trousers outer shell 30 may be sold, packaged, or provided with two or more trouser liners 38, one of which is shown in FIG. 5. Two connection portions, such as metal press studs (also known as snaps) 36 are provided at the bottom of the trouser legs for connection with the trouser liners 38. As shown in FIG. 5, the bottom of each leg of the trouser liner 38 is provided with a tab portion/protruding portion 40. A connection portion or metal press stud (or snap) 42 is provided on each tab portion 40 such that each snap 42 can be releasably connected to the press studs 36 shown in FIG. 4. However, it should be noted that a variety of fasteners may be utilized to attach each liner 38 to the shell 30, such as zippers, hooks, clasps, hook-and-loop fastening material (such as VELCRO® hook and loop fastening material) or the like.

In the same way that the jacket shell 2 of FIG. 1 is provided with two or more different liners 12, the trousers outer shell 30 may also be provided with two or more different trouser liners 38. For simplicity, only one trouser liner 38 is shown in FIG. 5 because the two trouser liners 38 may look substantially the same when drawn in black and white. For example, one of the trouser liners 38 (or part thereof, such as the tab 40) may be colored red and comply with NFPA 1971 standards. The other trouser liner 38 (or part thereof, such as the tab 40) may be colored green and comply with NFPA 1951 standards. Moreover, it should be noted that the trouser liners 38 may utilize various indicia besides color, such as the various indicia described above in the context of the jacket liners 12.

It will be appreciated that because the tab portions/protruding portion 40 of the trouser liners 38 are colored red or green, or carry other indicia thereon, they provide an important visual indication of which of the trouser liners 38 is being worn under the trouser outer shell 30. The interengaging press studs 36 and 42 ensure that the tab portions 40 protrude beyond the bottom of the legs of the outer shell 30 and remain visible at the bottom rear of each leg portion. For example, the press studs 36 and 42 ensure that the trouser liners 38 cannot slide up inside the outer shell 30, thus ensuring that the tab portions 40 remain visible at all times.

If desired, the trouser liners 38 may use the same color or indicia scheme as the jacket liners 12. In this case, for example, using the examples described above, if a green trouser liner 38 and a green jacket liner 12 are used, the wearer knows that NFPA 1971 requirements are complied with. Conversely, if a red trouser liner 38 and a red jacket liner 12 are used, the wearer knows that NFPA 1951 requirements are complied with. If mismatched liners 12, 38 are utilized, it may be determined that an inappropriate liner is being used.

It will be appreciated that the whole of the trouser liners 38 may be colored or carry the indicia, or just the tab portions 40 (or portions of the tab portions 40) may be colored or carry the indicia. If desired, the bottom edges and/or top edge of the liners 38 may instead, or in addition, carry the color/indicia and be considered the protruding portions.

In one embodiment, only a single liner 12, 38 can be worn in the associated shell 2, 30 at a time. Thus, for example, each shell 2, 30 be able to carry only a green, or only a red, liner at a time. In this case, each liner 12, 38 may only have enough fasteners to secure that liner to the outer shell, or may include fasteners that are incompatible with the fasteners of the other liner, or may include feature that physically prevent both liners from being simultaneously carried on the associated shell. However, it is within the scope of the present invention to provide a shell 2, 30 which can carry two (or more) liners 12, 38 at a single time, in which case the nature of the liners 12, 38 can still be indicated by their protruding portions. For example, each liner may have zipper portions that can cooperate with the zipper portions 14, 16 of the other liner. Each liner 12, 38 may have cut-outs, or a tiered shape or portions, or the like to allow colored/indicia portions of the underlying liner 12, 38 to be visible if they are simultaneously worn.

The trouser liners 38 are attached to the trousers outer shell 30 by concealed zips (not shown) in the trouser liners 38 and concealed zips (not shown) within the trouser outer shell 30. Various other attachment structures, such as hooks, clasps, snaps, hook-and-loop fastening material (such as VELCRO® hook and loop fastening material) or the like may be used to attach the trouser liners 38 to the trousers out shell 30. The trouser liners 38 are attachable into the trouser outer shell 30 to make one complete, integrated garment. The trouser outer shell 30 and trouser liners 38 may only comply with the relevant N.F.P.A./EN standards when they are worn as one complete garment.

The outer shells 2 and 30 may be made of or include a variety of materials, including a flame, heat and abrasion resistant material such as a compact weave of aramid fibers and/or polybenzamidazole fibers. Commercially available aramid materials include NOMEX and KEVLAR fibers (both trademarks of E.I. DuPont de Nemours & Co., Inc. of Wilmington, Del.), and commercially available polybenzamidazole fibers include PBI fibers (a trademark of PBI Performance Fabrics of Charlotte, N.C.). Thus, the outer shells 2, 30 may be an aramid material, a blend of aramid materials, a polybenzamidazole material, a blend of aramid and polybenzamidazole materials, or other appropriate materials. If desired, the outer shells 2, 30 may be coated with a polymer, such as a durable, water repellent finish (i.e. a perfluorohydrocarbon finish, such as TEFLON® finish sold by E.I. Du Pont de Nemours and Company of Wilmington, Del.).

Alternately, the outer shells 2, 30 may be constructed using 205 gr/m² thermostable organic polymer material, such as KERMEL® material. The KERMEL® material provides durability and has an excellent tear and tensile strength which is gained by using its “core spun para aramid” technology. The KERMEL® material also has colorfastness and does not readily fade or degrade in natural sunlight.

The liners 12/38 may consist of or include moisture barriers and/or thermal barriers. The moisture barrier of each liner 12/38 may be made of or include expanded polytetrafluoroethylene (“PTFE”) such as GORE-TEX or CROSSTECH materials (both of which are trademarks of W.L. Gore & Associates, Inc. of Newark, Del.), polyurethane-based materials, neoprene-based materials, cross-linked polymers, polyamid, or other materials. The moisture barrier may have microscopic openings that permit moisture vapor (such as water vapor) to pass therethrough, but block liquids (such as liquid water) from passing therethrough.

The moisture barrier may include a membrane layer made of a microporous material that is either hydrophilic, hydrophobic, or somewhere in between. The membrane layer may also be monolithic and may allow moisture vapor transmission therethrough by molecular diffusion. The membrane layer may also be a combination of microporous and monolithic materials (known as a bicomponent moisture barrier), in which the microporous or monolithic materials are layered or intertwined. The membrane layer may be bonded or adhered to a substrate of a flame and heat resistant material to provide structure and protection to the membrane layer. The substrate may be or include aramid fibers similar to the aramid fibers of the outer shell, but may be thinner and lighter in weight.

If each liner 12/38 includes a thermal barrier, the thermal barrier may be made of nearly any suitable material that provides sufficient thermal insulation. In one embodiment, the thermal barrier may include a relatively thick (i.e. between about 1/16″ and about 3/16″) batting, felt or needled non-woven bulk or batting material which can include aramid fiber batting (such as NOMEX batting), aramid needlepunch material, an aramid non-woven material, an aramid blend needlepunch material, an aramid blend batting material, an aramid blend non-woven material, or foam (either open cell or closed cell) materials. The batting may trap air and possess sufficient loft to provide thermal resistance to the garment. The batting is typically quilted to a thermal liner face cloth which can be a weave of a lightweight aramid material.

Furthermore, in order to provide chemical or other protection, each liner 12/38 may be made of or include CHEMPAK® ULTRABARRIER™ sold by W.L. Gore & Associates, Inc. of Newark, Del., NOMEX® material sold by E.I. DuPont de Nemours and Company of Wilmington, Del. Each liner 12/38 may be made of or include a generally fluid/gas impermeable layer; in one case polytetrafluoroethylene (“PTFE”) such as TEFLON® PTFE sold by E.I. DuPont de Nemours of Wilmington, Del.

The inner liners 12 and 38 may be provided in two types: 1) EN469:1995 & EN 469:2005 Level 2—Structural (i.e., having red collar 20 and/or tab 40); and 2) EN 469:2005 Level 1—Non-Structural (i.e. having a green collar 20 and/or tab 40). The Level 2 Structural liner (12 or 38) is constructed using the Crosstech® Airlock® by WL Gore (Airlock was developed by Lion Apparel) quilted onto ISOMEX® ISOAIR with a Nomex® Viscose inner liner. This liner 12/38 (when inserted into the outer shell 2/30) will provide full EN469 protection to the wearer whilst giving the wearer the added benefits of being lightweight, breathable and comfortable.

The Level 1 Non-Structural liner (12 or 38) incorporates Crosstech® SR fabric that provides the user with extra protection against blood borne pathogens and body fluids, the elements and common chemicals. This liner (when inserted into the outer material) will offer the wearer full protection that is required by EN 469:2005 Level 1—Non-Structural.

The jacket outer shell 2 may have the following features:

KERMEL® HTA, colors: blue-grey, red, 205 gr/m²

Ripstop, oil-water repellency treatment

Additional fireblocker N 21 in stormflap

Protective storm flap solution with collar extension

Gusset underarm ensuring upper body movement and complete arm mobility

Adjustable waist solution

2 bellowed pockets with pocket flap and tag

Torch and radio loops on both chests

Sleeve pocket, angled position for easier access

Important seams are topstitched

All stress points are bartacked

Shoulder reinforcement/double layer of outer+foam

Elbow reinforcement/double layer of outer+foam

Arashield coated sleeve ends (Arashield is the brand name for a specially developed Lion Apparel coated Kevlar®)

Neoprene coated sleeve ends

Breathable, reflective 50 mm triple trim,

30 mm Velcro® front closure

NOMEX® cuff ribbing

NOMEX® thread used throughout

The Level 2 Structural jacket liner 12 may be provided with moisture and thermal barriers having the following characteristics:

Moisture Barrier: CROSSTECH® Airlock 21
Waterproof, breathable, viral penetration resistant moisture membrane
All seams are fully taped

Thermal Barrier: Quilted composite made of: perforated needle-felt, made of meta- and para-aramid fibres, hydrophobic finishing treatment
ISO' AIR® ISODRI® WIP 4199-95 gr/m²
a fabric NOMEX®-Viscose FR, 110 gr/m²

The Level 1, Non-Structural-structural jacket liner 12 may be provided with moisture and thermal barriers having the following characteristics:

Moisture Barrier: CROSSTECH® SR 21
Waterproof, breathable, viral penetration resistant moisture membrane
All seams are fully taped

Thermal Barrier: Laminated composite made of: Non woven aramid E89; and a fabric Aramid/Viscose FR

The trousers outer shell 30 may have the following features:

KERMEL® HTA, colors: yellow-gold, 205 gr/m²

Ripstop, oil-water repellency treatment

Knee reinforcement with Arashield+foam (Arashield is the brand name for a coated Kevlar® developed by Lion Apparel, Inc.,)

Breathable, reflective 50 mm triple trim

NOMEX® thread used throughout

Zip fly opening

Extra comfortable elasticated shoulder braces with quick release buckles

Brace length adjustable

Adjustable waist

Belt loops

Elasticated center back

2 bellowed pockets with pocket flap and tag

Ergonomic design of knee area for more comfort when kneeling

Zip fly opening with gusset on outside leg for easier access

Adjustable leg seam

Important seams are topstitched

All stress points are bartacked

The Level 1, Structural trouser liner 38 may be provided with moisture and thermal barriers having the following characteristics:

Moisture Barrier: CROSSTECH® Airlock 21
Waterproof, breathable, viral penetration resistant moisture membrane
All seams are fully taped

Thermal Barrier: Quilted composite made of: perforated needle-felt, made of meta- and para-aramid fibres, hydrophobic finishing treatment
ISO' AIR® ISODRI® WIP 4199-95 gr/m²
a fabric NOMEX®-Viscose FR, 110 gr/m²

The Level 2, non-structural trouser liner 38 may be provided with moisture and thermal barriers having the following characteristics:

Moisture Barrier: CROSSTECH® SR 21
Waterproof, breathable, viral penetration resistant moisture membrane
All seams are fully taped

Thermal Barrier: Laminated composite made of:
Non woven aramid E89
a fabric Aramid/Viscose FR

Each layer of the jacket and trousers, and the jacket/trousers as a whole, may meet the National Fire Protection Association (“N.F.P.A.”) 1971 standards for protective firefighting garments (“Protective Clothing for Structural Firefighting”), and/or NFPA 1951 standards for technical rescue garments, the contents of both of which are entirely incorporated by reference herein. The NFPA standards specify various minimum requirements for heat and flame resistance, tear strength, protection from liquids and pathogens, etc. For example, in order to meet the NFPA 1971 standards, the outer shell, moisture barrier and thermal liner must be able to resist igniting, burning, melting, dripping and/or separation at a temperature of 500° F. for at least five minutes. Furthermore, in order to meet the NFPA 1971 standards, all combined layers of the jacket/trousers must provide a thermal protective performance rating of at least thirty-five.

While particular embodiments of the present invention have been illustrated and described herein, it should be apparent to those skilled in the art that various additional changes and modifications can be made without departing from the spirit and scope of the present invention. It is therefore intended that all such changes and modifications that are within the scope of this invention.

What is claimed is:

1. A garment outer shell and liner system comprising:
a garment outer shell;
a first liner having first protective properties and having a protruding portion; and
a second liner having second protective properties differing from said first protective properties and having a protruding portion, wherein each liner is adapted to fit within, and is removably securable to, said outer shell, and wherein each protruding portion is arranged to protrude from said outer shell when the respective liner is secured within the outer shell, and wherein at least a portion of said protruding portion of said first liner is a first color to indicate said first protective properties, and at least a portion of said protruding portion of said second liner is a second color to indicate said second protective properties.

2. The system of claim 1 wherein substantially the entirety of said protruding portion of said first liner is said first color, and wherein substantially the entirety of said protruding portion of said second liner is said second color.

3. The system of claim 1 wherein substantially the entirely of said first liner is said first color, and substantially the entirety of said second liner is said second color.

4. The system of claim 1 wherein when said first liner is secured within said outer shell the resultant outer shell and liner assembly complies with N.F.P.A. 1971 standards for protective firefighting garments, and wherein when said second liner is secured within said outer shell the resultant outer shell and liner assembly complies with N.F.P.A. 1951 standards for technical rescue garments.

5. The system of claim 1 wherein said first color is red and wherein said second color is green.

6. The system of claim 1 wherein said garment outer shell is a jacket outer shell, and wherein said first and second liners are first and second jacket liners.

7. The system of claim 6 wherein said first and second jacket liners are provided with collars which form the associated protruding portions.

8. The system of claim 1 wherein said garment outer shell is a trousers outer shell, and wherein said first and second liners are first and second trouser liners.

9. The system of claim 8 wherein said first and second trouser liners are provided with first and second tabs at the bottom of the first and second trouser liners, respectively, and wherein the first and second tabs form the associated protruding portions respectively.

10. The system of claim 9 wherein said first and second tabs are releasably securable to an outer portion of said trousers outer shell so that said first and second tabs are clearly visible during use of the system.

11. The system of claim 10 wherein said first and second tabs and said trousers outer shell are provided with cooperating connection portions such that the tabs are releasably securable to said outer shell.

12. The system of claim 1 wherein said first and second differing protective properties are thermal protective properties.

13. The system of claim 1 wherein when said first liner is secured within said outer shell the resultant outer shell and liner assembly complies with a first N.F.P.A. standard, and wherein when said second liner is secured within said outer shell the resultant outer shell and liner assembly complies with a second N.F.P.A. standard, but does not comply with said first N.F.P.A. standard.

14. The system of claim 1 wherein each liner is adapted to fit within and be removably secured to said shell such that only a single liner can be fit within and removably secured to said outer shell at a time.

15. The system of claim 1 further comprising a third liner having third protective properties differing from said first and second protective properties and having a protruding portion, wherein said third liner is adapted to fit within, and is removably securable to, said outer shell, and wherein said protruding portion of said third liner is arranged to protrude from said outer shell when said third liner is secured within the outer shell, and wherein at least a portion of said protruding portion of said third liner is a third color so as to indicate said third protective properties.

16. The system of claim 1 wherein said garment outer shell is a jacket outer shell, and wherein said first and second liners are first and second jacket liners, and wherein the system further includes:
a trousers outer shell;
a first trouser liner having first protective properties and having a protruding portion; and
a second trouser liner having second protective properties differing from said first protective properties and having a protruding portion, wherein each trouser liner is adapted to fit within, and is removably securable to, said trousers outer shell, and wherein each protruding portion of said trouser liners are arranged to protrude from said trousers outer shell when the respective trouser liner is secured within the trousers outer shell, and wherein at least a portion of said protruding portion of said first trouser liner is said first color so as to indicate said first protective properties, and at least a portion of said protruding portion of said second trouser liner is said second color so as to indicate said second protective properties, such that when said jacket outer shell with said first jacket liner is worn along with said trousers outer shell with said first trouser liner a first set of garment regulations are met, and wherein when said jacket outer shell with said second jacket liner is worn along with said trousers outer shell with said second trouser liner a second set of garment regulations are met.

17. A garment outer shell and liner system comprising:
a jacket outer shell;
a first jacket liner having a protruding portion with a first indicia;
a second jacket liner having a protruding portion with a second indicia;
a trousers outer shell;
a first trouser liner having a protruding portion with said first indicia; and
a second trouser liner having a protruding portion with said second indicia, wherein each liner is adapted to fit within and be removably secured to the associated outer shell such that each protruding portion protrudes from the associated outer shell, and wherein when said first jacket liner is removably secured to said jacket outer shell the resultant jacket assembly complies with a first N.F.P.A. regulation, and wherein when said first trouser liner is removably secured to said trouser outer shell the resultant trouser assembly complies with said first N.F.P.A. regulation, wherein when said second jacket liner is removably secured to said jacket outer shell the resultant jacket assembly complies with a second N.F.P.A. regulation but not said first N.F.P.A. regulation, and wherein when said second trouser liner is removably secured to said trouser outer shell the resultant trouser assembly complies with said second N.F.P.A. regulation, but not said first N.F.P.A. regulation.

18. A garment outer shell and liner system comprising:
an outer shell;
a first liner having a first protective property and a protruding portion; and
a second liner having a second protective property differing from said first protective property and having a protruding portion, wherein each liner is adapted to fit within and be removably secured to said outer shell such that only one of said liners can be fit within and removably secured to said outer shell at a time, and wherein each protruding portion is arranged to protrude from said outer shell and be visible by a non-wearer of the outer shell when the respective liner is fit within and removably secured to the outer shell, and wherein at least a portion of said protruding portion of said first liner has a first optical property to indicate said first protective property, and wherein at least a portion of said protruding portion of said second liner has a second optical property that is different from said first optical property to indicate said second protective property.

19. The system of claim 18 wherein said first and second optical properties differ due to a color, or a pattern, or texture, or symbol, or shading, or text, or reflective material, or fluorescent material, or combinations thereof.

20. The system of claim 18 wherein said differing optical properties take the form of differing indicia.

21. The system of claim 18 wherein said first and second optical properties are differing colors.

22. A method for using a garment outer shell and liner system comprising:
providing a garment outer shell, a first liner having first protective properties and having a protruding portion having a first color, and a second liner having second protective properties and having a protruding portion having a second color;
coupling said first liner to said outer shell such that said first liner fits within, and is removably secured to, said outer shell, and wherein said color of said protruding portion of said first liner protrudes from said outer shell to indicate said first protective properties; and
coupling said second liner to said outer shell such that said second liner fits within, and is removably secured to, said outer shell, and wherein said color of said protruding portion of said second liner protrudes from said outer shell to indicate said second protective properties.

23. The method of claim 22 further comprising the step of, after the first coupling step and before the second coupling step, removing said first liner from said outer shell.
